(19) United States
(12) Patent Application Publication
(10) Pub. No.: US 2015/0379558 A1
(43) Pub. Date: Dec. 31, 2015

(54) DETECTING UNINTENTIONAL USER INPUT TO MOBILE ADVERTISEMENTS

(71) Applicant: Celtra Inc., Cambridge, MA (US)

(72) Inventors: Jaka Jancar, Ljubljana (SI); Grega Kespret, Ljublijana (SI); Matevz Klanjsek, San Francisco, CA (US); Gasper Kozak, San Francisco, CA (US)

(73) Assignee: Celtra Inc., Cambridge, MA (US)

(21) Appl. No.: 14/316,242

(22) Filed: Jun. 26, 2014

(51) Int. Cl. G06Q 30/02

(52) U.S. Cl. CPC G06Q 30/0246; G06Q 30/0267

(57) ABSTRACT

Some embodiments of the invention provide techniques for identifying unintentional input to a mobile advertisement. Unintentional user input may be identified by determining a time interval between events (e.g., two events) relating to the user's interaction with the mobile advertisement, and comparing the time interval to a threshold time interval (e.g., a predetermined, static threshold time interval). If the time interval is shorter than the threshold time interval, then the user's input is determined to be unintentional. If the user's input is determined to be unintentional, then statistics relating to serving of the ad may be adjusted accordingly, so that the unintentional input does not skew ad performance metrics, and does not cause the advertiser to bear unnecessary costs.

### FIELD OF INVENTION

This invention relates generally to mobile advertising, and more particularly to determining when user input to a mobile advertisement is unintentional.

### BACKGROUND

A mobile advertisement is one which is designed for display on a mobile device (e.g., a handheld device, such as a smart phone or tablet computer, a dash-top device Do such as a GPS navigation device, a satellite radio receiver, a mobile payment platform, a content reproduction device such as an MP3 player, a video game console, or any other type of portable device). A mobile advertisement may be presented to a user on a mobile web page (i.e., by a browser application executing on the mobile device), within a mobile application (i.e., “in-app,” by the user interface presented by an application accessible via the mobile device, whether native to the mobile device or not), and/or in some other fashion.

A mobile advertisement may take any of numerous forms. Example types of mobile advertisements include banner ads (which may be shown to a viewer at the top or bottom of his/her mobile display screen), expandable banner ads (which expand from a banner at the top or bottom to occupy a larger portion of the screen), interstitial ads (which are typically presented “between” pages of a mobile website, while the content of a target webpage to which a viewer desires to navigate downloads), and other types.

Often, a mobile advertisement initially occupies only a limited amount of the viewable area on the mobile device's screen, and the user supplies input (e.g., touch input, voice input, and/or any other suitable form of input) to the advertisement to request additional content. For example, user input to an expandable banner ad may cause the ad to expand to occupy more of the viewable area on the mobile device's screen, and the expanded ad may present additional information on the advertised products and/or services. With ads providing so-called “rich media,” user input may cause content and/or components to be served to the mobile device which are designed to provide an engaging experience and connect with the user.

### SUMMARY

The inventors have appreciated that users of mobile devices sometimes unintentionally provide input to mobile advertisements. Unintentional user input may occur for any of numerous reasons. For example, unintentional input may occur because the location of an ad on a mobile web page shifts while the content of the page (including the ad) is loading. The user may, for example, inadvertently “tap” the mobile device's screen in a region where the ad is located while the page's content is in the process of loading, mistakenly causing a request for content relating to advertised products or services to be issued. Unintentional input may also occur if a user's fingers are large in relation to the size of the device's screen, as the user may have difficulty providing touch input with sufficient precision to avoid the area occupied by an ad. Unintentional input may also occur if an ad is located near components with which the viewer often interacts (e.g., menus, buttons, etc.), if an ad is similar in visual appearance to other content displayed on the screen, and/or if an ad is hidden within the viewable area but is still receptive to user input.

Unintentional user input may have adverse consequences for advertisers. For example, a user who unintentionally causes a banner ad to expand may become frustrated after being served content which he/she did not mean to request, and may associate this frustration with the advertised products and/or services. Unintentional user input may also make it difficult for advertisers to determine how effective an ad is at attracting the user's attention. Moreover, in a “pay-per-click” advertising model, advertisers pay publishers (e.g., mobile website owners, mobile application owner, etc.) whenever its ad is clicked by the user. As such, unintentional user input may cause advertisers to bear unnecessary costs.

To remedy these and other deficiencies, some embodiments of the invention provide techniques for identifying unintentional input to a mobile advertisement. In some embodiments of the invention, unintentional user input may be identified by determining a time interval between events (e.g., two events) relating to the user's interaction with a mobile advertisement, and comparing the time interval to a threshold time interval. If the determined time interval is shorter than the threshold time interval, then the user's input may be deemed unintentional. If so, performance metrics relating to the ad may be adjusted accordingly, so that the ad's success in engaging users may be accurately assessed, and the advertiser does not bear unnecessary costs.

The foregoing is a non-limiting summary of some aspects of the invention, some embodiments of which are defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart depicting a representative process for determining whether a user's input to a mobile advertisement is unintentional, in accordance with some embodiments of the invention;

FIG. 2 is a time series representation of events relating to user input to a mobile advertisement provided to illustrate some embodiments of the invention;

FIG. 3 is a time series representation of events relating to user input to a mobile advertisement provided to illustrate some embodiments of the invention;

FIG. 4 is time series representation of events relating to user input to a mobile advertisement provided to illustrate some embodiments of the invention;

FIG. 5 is a time series representation of events relating to user input to a mobile advertisement provided to illustrate some embodiments of the invention;

FIG. 6 is a representation of a screen interface portion showing example statistics relating to a user's interaction with a mobile advertisement; and

FIG. 7 a block diagram depicting a representative computer system with which various aspects of embodiments of the invention may be implemented.

### DETAILED DESCRIPTION

In some embodiments of the invention, techniques are provided for identifying unintentional input to a mobile advertisement. Unintentional user input may be identified, for example, by measuring a time interval between events relating to the user's interaction with the mobile advertisement. The measured time interval may be compared to a threshold time interval (e.g., a predetermined threshold time interval). If the measured time interval is shorter than the threshold time interval, then the user's input to the mobile advertisement may be deemed unintentional.

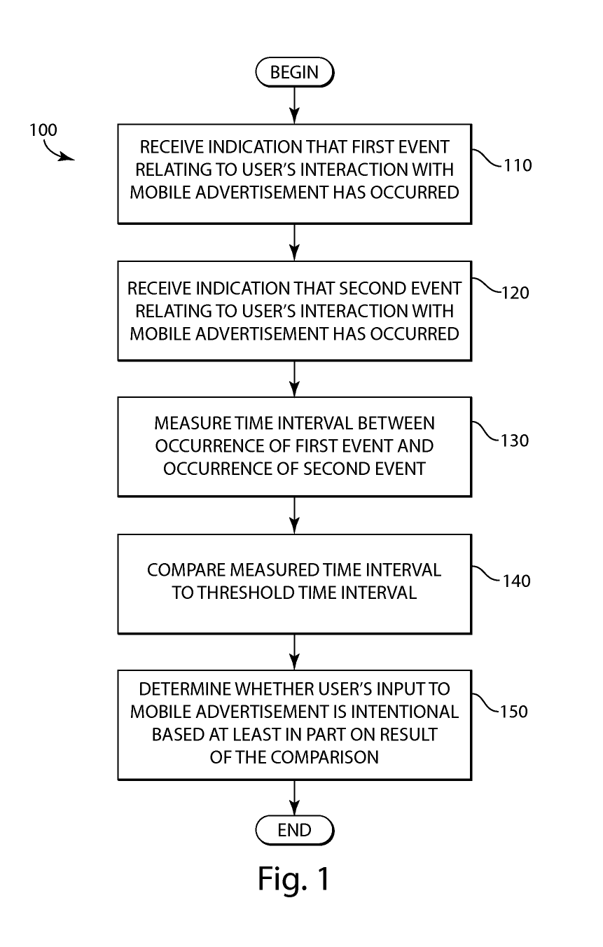

FIG. 1 depicts a representative process 100 for determining whether a user's input to a mobile advertisement is unintentional. Representative process 100 begins with act 110, wherein an indication is received that a first event relating to the user's interaction with the mobile advertisement has occurred. The first event may comprise any suitable occurrence and/or combination (e.g., sequence) of occurrences. For example, in some embodiments of the invention, the first event may comprise an occurrence such as the initial presentation of a mobile advertisement by a mobile device (e.g., a visual display of the mobile advertisement within the viewable area of the mobile device's screen display), receipt of user input requesting that content relating to a mobile advertisement be served to the mobile device, presentation of content relating to an advertised product and/or service, any other suitable occurrence, or some combination or sequence of the above-listed events.

Identification that the first event has occurred may be performed in any suitable way. In some embodiments of the invention, programmed instructions executing on the mobile device may detect that the first event has occurred. It should be appreciated, however, that embodiments of the invention are not limited to such a mode of implementation. For example, if programmed instructions are executed to detect the occurrence of the first event, then these instructions may be executed by any suitable component, such as a server component (e.g., an ad server component, which may be distributed across any suitable number of physical devices) with which the mobile device communicates, and/or one or more other components. For example, programmed instructions for detecting the occurrence of the first event may execute on both the mobile device and a server component. Any suitable components may be deployed, in any suitable configuration, to detect the occurrence of the first event.

Representative process 100 then proceeds to act 120, wherein an indication is received that a second event relating to the user's interaction with the mobile advertisement has occurred. Like the first event, the second event may comprise any suitable occurrence and/or combination (e.g., sequence) of occurrences. For example, in some embodiments, the second event may comprise receipt of user input requesting that content relating to an advertised product and/or service be served to the mobile device, receipt of user input requesting that the loading or display of such content be discontinued, any other suitable occurrence, or some combination of the above-listed events. Identification that the second event has occurred may be performed in any suitable way, such as via execution of programmed instructions by the mobile device, by a component with which the mobile device communicates (e.g., a server component), or some combination thereof.

At the completion of act 120, representative process 100 proceeds to act 130, wherein a time interval is measured between the occurrence of the first event and the occurrence of the second event. This may be performed in any suitable way, by any suitable component(s). For example, in some embodiments of the invention, the indications received in the acts 110 and 120 may indicate the times at which the first and second events occurred, and these times may be used to determine the time interval between the events. This determination may be performed, for example, via execution of programmed instructions by the mobile device, by a component with which the mobile device communicates, and/or by any other suitable component.

Representative process 100 then proceeds to act 140, wherein the time interval determined in the act 130 is compared to a threshold time interval. Any suitable threshold time interval may be employed, and the threshold time interval may be defined in any suitable fashion. In some embodiments of the invention, a threshold time interval may be defined in relation to an amount of time that it takes an average user to visually process information that is presented by a mobile device (e.g., displayed within a viewable area of a screen display of the mobile device). This amount of time may be established in any suitable fashion, such as based upon empirical study of the behavior of a population of users, and/or based upon knowledge of human users' cognitive limitations. For example, if it is known that it takes a human user at least a certain amount of time to visually process the information shown on the screen of a mobile device, then the threshold time interval may be defined in relation to this amount of time (e.g., the threshold time interval may equal this amount of time). As such, some embodiments of the invention may reflect a recognition that if first and second events relating to a user's interaction with a mobile advertisement occur within a time interval that is shorter than the amount of time needed by the average user to visually process information shown on the screen, then this may indicate that user input is unintentional. For example, if a first event is the initial display of an ad on the mobile device's screen, the second event is the receipt of user input to request additional content on an advertised product, and the second event occurred in less time after the first event than it takes a user to visually process information, then a conclusion may be drawn that the user's input (i.e., that which requests additional content on the advertised product) was unintentional.

Of course, it should be appreciated that a threshold time interval need not be defined in relation to an amount of time that it takes a user to visually process information. In this respect, a threshold time interval need not be predefined (e.g., it may be defined dynamically, based on, for example, prior user behavior and/or user circumstances). In addition, a threshold time interval need not be the same for all users, mobile devices and circumstances. For example, it may be determined based upon monitoring a particular user's interaction with a mobile device that he/she takes more time than the average person to process information visually, and so the threshold time interval may be longer for that user than for other users. In another example, it may be observed that some users take longer to respond to visual stimuli at certain times of the day (e.g., early in the morning, later at night, etc.), and so the threshold time interval for those users may be longer during some parts of the day than others. A threshold time interval may be defined in any suitable way, based upon any suitable consideration(s), as embodiments of the invention are not limited in this respect.

Representative process 100 then proceeds to act 150, wherein a determination is made whether user input to the mobile advertisement is unintentional based at least in part upon the comparison between the measured time interval and the threshold time interval in the act 140. For example, in some embodiments, it may be determined that the user's input is unintentional if the measured time interval is shorter than the threshold time interval. In other embodiments, a determination that user input is unintentional may be based upon some other relationship between the measured time interval and the threshold time interval.

At the completion of act 150, representative process 100 completes.

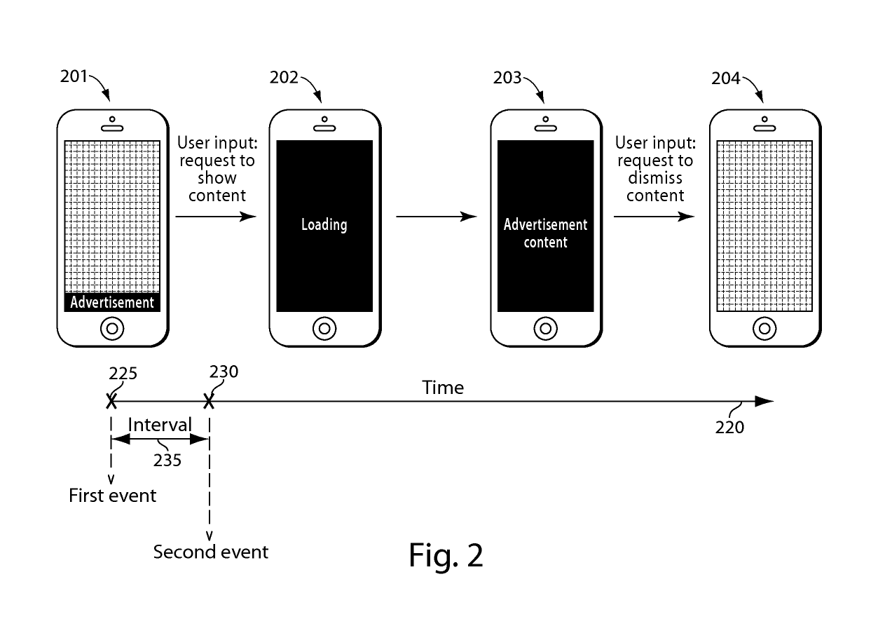

FIGS. 2-5 each show example sets of occurrences which may be analyzed to determine whether a user's input to a mobile advertisement is unintentional. The set of occurrences shown in each of FIGS. 2-5 is illustrated in relation to a sequence of events that includes a mobile advertisement 218 being initially displayed to a user (as represented at 201), content relating to an advertised product and/or service being loaded to the mobile device in response to user input (as represented at 202), the content being displayed by the device (as represented at 203), and display of the content being discontinued in response to user input (as indicated at 204). Timeline 220 represents the passage of time as this sequence unfolds.

In the example shown in FIG. 2, the occurrences that are analyzed to determine whether a user's input to a mobile advertisement is unintentional include the initial display of the mobile advertisement by the device and receipt of user input to request that content relating to an advertised product and/or service be loaded to the device. The initial display of the mobile advertisement constitutes the first event, located on timeline 220 at position 225, and the receipt of the user's input constitutes the second event, located on timeline 220 at position 230. The time interval between the first event and the second event is represented at 235. As described above, time interval 235 may be compared to a threshold time interval, and a determination whether the user's input to the mobile advertisement (in this example, that which requests that additional content be loaded) is unintentional may be based at least in part on this comparison.

In some embodiments of the invention, the threshold time interval may be established as 700 milliseconds, since the inventors' observation is that this is about the amount of time that it takes an “average” user to visually process information shown on a mobile device's display screen. Thus, in this example, if interval 235 is less than 700 milliseconds, then it may be determined that the user's input to the mobile advertisement was unintentional, as the short interval between the mobile advertisement's initial display and the user's input to the mobile advertisement indicates that the user was unable to visually process the advertisement before providing the input, so that the input must have been unintentional.

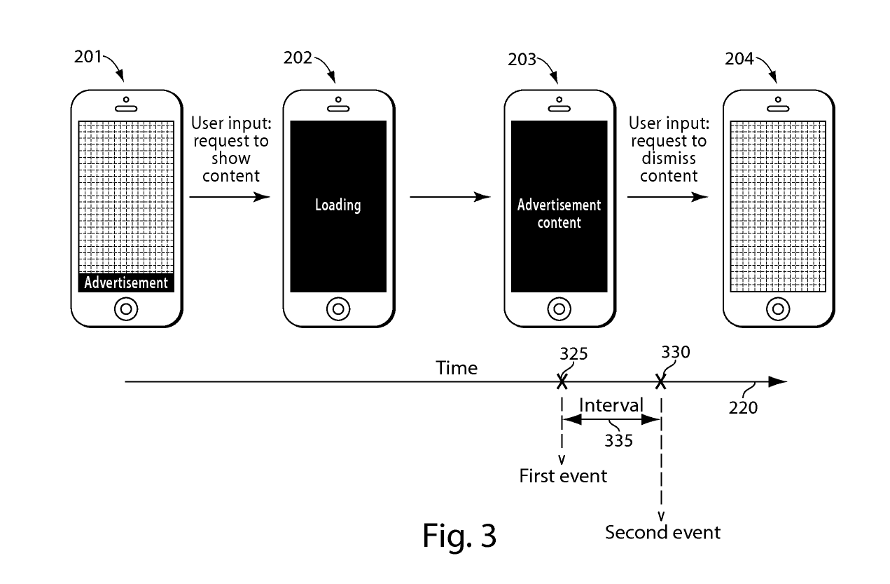

Another example set of occurrences is shown in FIG. 3. In this example, the first event is the display of content on an advertised product and/or service in response to a user's request (located on timeline 220 at position 325), and the second event is the receipt of the user's request to discontinue display of the requested content (located on timeline 220 at position 330). The time interval between the first event and the second event is represented at 335. Time interval 335 may be compared to a threshold time interval, and a determination whether the user's input to the mobile advertisement (in this example, the input requesting that content be loaded) was unintentional may be based at least in part on the result of the comparison. For example, if time interval 335 is shorter than 700 milliseconds, then it the user's input may be deemed unintentional, as the short interval between the display of content and the user's request to discontinue that display may indicate that the user did not mean to request the content.

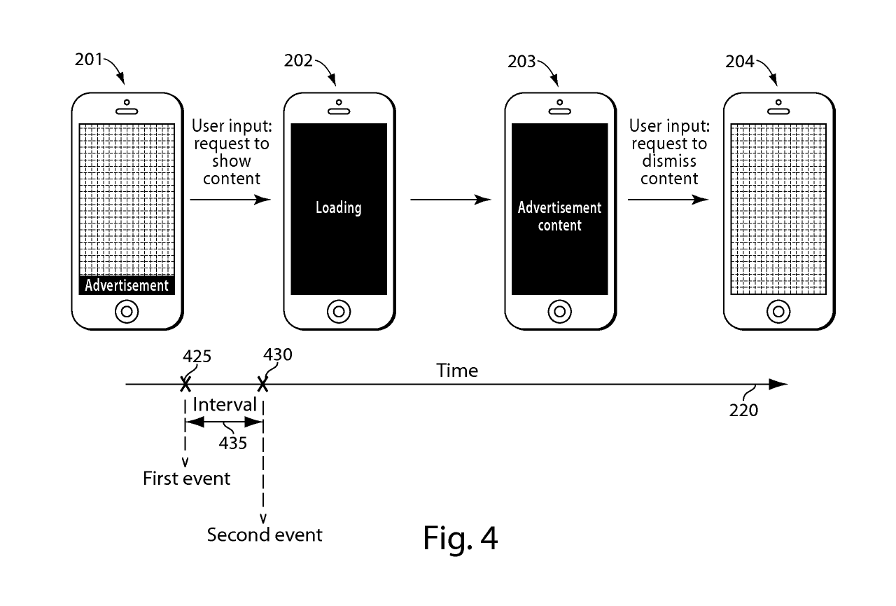

In the example shown in FIG. 4, the first event is the user's input to the ad requesting that content be loaded (located on timeline 220 at position 425), and the second event is receipt of the user's request to discontinue loading of the content (located on timeline 22C) at position 430). The time interval between the first event and the second event is represented at 435. This time interval may be compared to a threshold time interval, and a determination whether the user's input to the mobile advertisement (in this example, the input requesting that content be loaded) was unintentional may be made based at least in part on a result of the comparison. For example, if time interval 435 is shorter than 700 milliseconds, then the user's input may be deemed unintentional, as the short interval between the user's request to load content and the user's request to discontinue the loading of content may indicate that the user did not mean to request that the content be loaded.

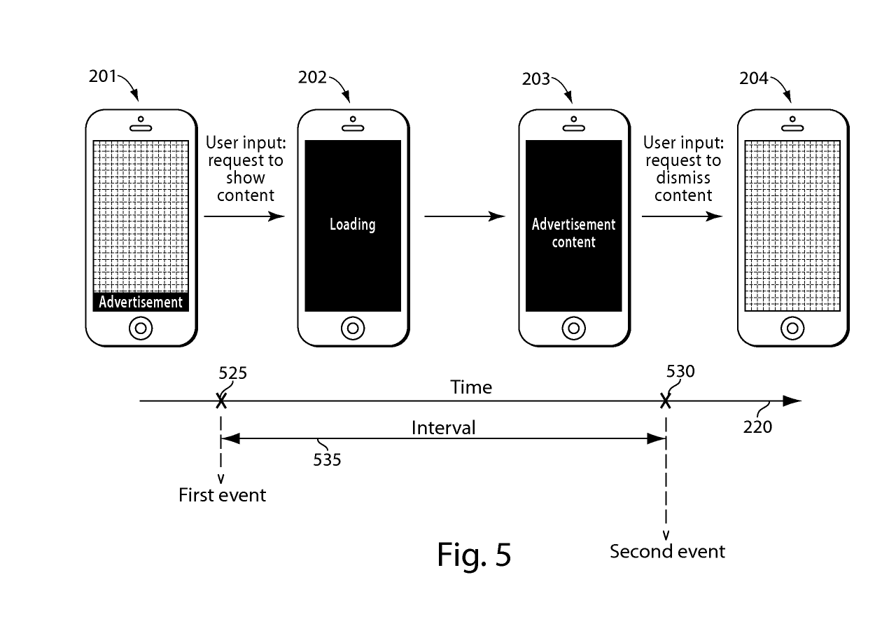

Another example is shown in FIG. 5. In this example, the first event is the receipt of user input to request content relating to the advertised product and/or service (located on timeline 220 at position 525), and the second event is receipt of the user's request to discontinue display of the content (located on timeline 220 at position 530). The time interval between the first event and the second event is represented at 535. This interval may be compared to a threshold time interval, and a determination whether the user's input (in this example, the request to load the content) was unintentional may be based at least in part on the result of this comparison. For example, if time interval 535 is shorter than 700 milliseconds, then a conclusion may be drawn that the user's request to load the content was unintentional, as the short interval between this request and a second request to discontinue the loading) may indicate that the user did not intend for the content to be loaded.

It should be appreciated that the examples described above with reference to FIGS. 2-5 are intended to be illustrative but non-limiting. Any suitable set(s) of events may be analyzed to determine whether a user's input to a mobile advertisement is unintentional, including sequences of events not described above. In this respect, although the examples described above relate to analyzing two occurrences (i.e., a first event and a second event) to determine whether a user's input to an advertisement was unintentional, not all embodiments of the invention are limited to such an implementation, as any suitable number of occurrences may be analyzed to determine whether a user's input is unintentional.

Further, although the time interval between the first event and the second event in each example described above is compared to the same static threshold time interval (i.e., 700 milliseconds), some embodiments of the invention may involve comparing a measured time interval against a threshold time interval which varies according to event, user, device, circumstance, and/or other consideration. For example, the measured time interval in the example described above in relation to FIG. 2 may be compared to a first threshold time interval, the measured time interval in the example described above in relation to FIG. 3 may be compared to a second threshold time interval, etc. A measured time interval may be compared to any suitable threshold time interval.

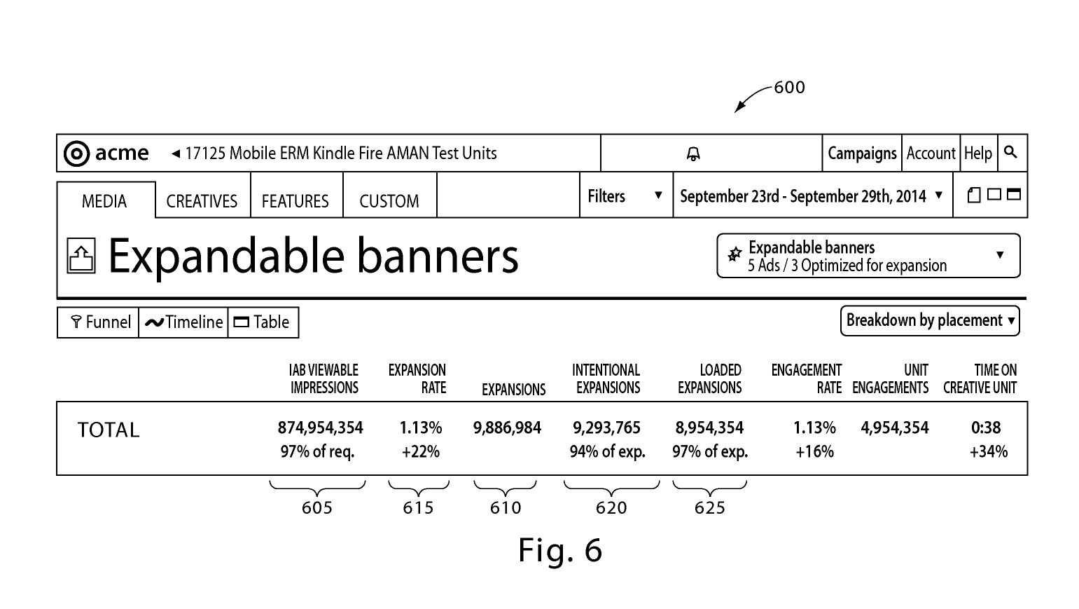

As noted above, unintentional user input may make it difficult for advertisers to determine how effective an advertisement is at attracting users' attention, and may result in advertisers bearing unnecessarily higher costs in a “pay-per-click” advertising model. FIG. 6 illustrates how identifying unintentional user input to an advertisement may reduce unnecessary advertiser costs, and provide advertisers with a more accurate picture of how effective an advertisement is at engaging users. In this respect, FIG. 6 shows sample statistics 600 which may be provided to an advertiser for a representative expandable banner advertisement. The statistics indicate that the expandable banner advertisement was displayed to users a total of 874,954,354 times (as shown at 605), and that the advertisement was expanded by users 9,886,984 times (as shown at 610), meaning that users provided input to the advertisement 1.13% of the time it was shown (as shown at 615). In a conventional “pay-per-click” arrangement, the advertiser would be liable to a publisher for all of the 9,886,984 expansions.

However, statistics 600 also indicate that of the total 9,886,984 expansions, only 9,293,765 (as shown at 620) resulted from intentional user input, or 94% of the total number of expansions. Statistics 600 also indicate that of the 9,293,765 intentional expansions shown at 620, only 8,954,354 resulted in content being loaded to a user's mobile device (as shown at 625), perhaps indicating that the user discontinued the loading of content in the remaining instances. Thus, depending on the arrangement that the advertiser has with the publisher, the advertiser may be liable for 9,293,765 expansions, or 8,954,354 expansions, rather than 9,886,984 expansions. This may represent a significant cost savings for the advertiser.

In addition to helping advertisers avoid unnecessary costs, statistics like those shown in FIG. 6 may be used to help to improve users' experience with advertisements over time. In this respect, if an analysis of advertisements with low intentional expansions-to-total expansions ratios (as one example) and/or low loaded expansions-to-total expansions ratios (as another example) reveals that these advertisements tend to share common characteristics (e.g., the advertisements tend to occupy a particular portion of the total display area, are located near components with which the viewer often interacts, are similar in visual appearance to other content displayed on the screen, and/or have other common characteristics), then advertisers may avoid creating advertisements with those characteristics going forward, thus reducing the likelihood that users will unintentionally provide input and become frustrated when they are served content which they did not wish to see.

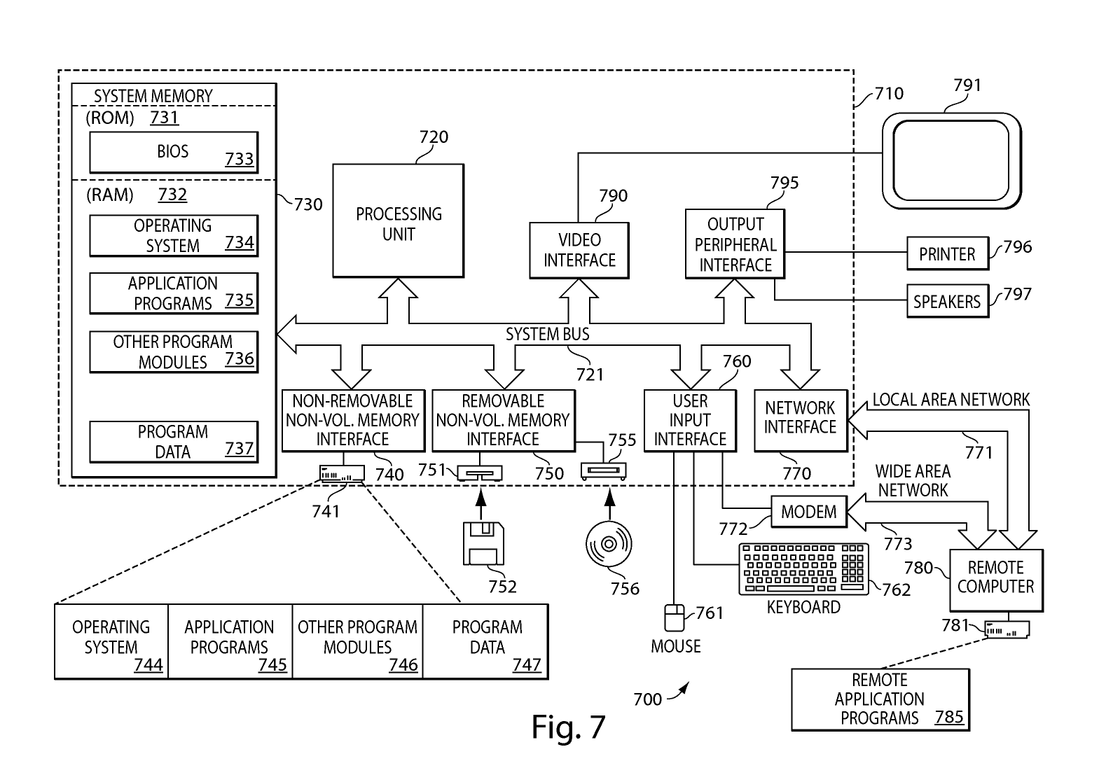

It should be appreciated from the foregoing that some aspects of the invention may be implemented via a computing system, such as a mobile device which displays a mobile advertisement to a user, or a device in networked communication with such a mobile device (e.g., upon which a server component executes). FIG. 7 illustrates one example of a suitable computing system environment 700 which may be used to implement certain aspects of the invention. The computing system environment 700 is only one example of a suitable computing environment, and is not intended to suggest any limitation as to the scope of use or functionality of the invention. Neither should the computing environment 700 be interpreted as having any dependency or requirement relating to any one or combination of components illustrated in the representative operating environment 700. In this respect, the invention is operational with numerous general purpose or special purpose computing system environments or configurations. Examples of well-known computing systems, environments, and/or configurations that may be suitable for use with the invention include, but are not limited to, handheld mobile devices (e.g., smartphones, tablet computers, dash-top devices, satellite radio receivers, mobile payment devices, content reproduction devices, video game consoles, etc.), server computers, personal computers, laptop devices, multiprocessor systems, microprocessor-based systems, set top boxes, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 7 depicts a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 710. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through an non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through a output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks such as one or more enterprise networks, intranets and/or the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, FIG. 7 illustrates remote application programs 785 as residing on memory device 781. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, although a processor may be implemented using circuitry in any suitable format.

A computer may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include touch-sensitive screens, keyboards and pointing devices, such as mice, touch pads, and digitizing tablets. As another example, a computer may receive input information through speech recognition or in other audible format.

Computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., an article of manufacture) or a machine. Alternatively, the invention may be embodied as a computer readable medium which is not a computer-readable storage medium. For example, the invention may be embodied as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to some embodiments of the invention, one or more computer programs that, when executed, implement aspects of the invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in relation to one embodiment may be combined in any manner with aspects described in relation to other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. At least one computer-readable storage medium having instructions encoded thereon which, when executed by a computer system, cause the computer system to perform a method of determining whether a user's input to a mobile advertisement is unintentional, the method comprising acts of:
(A) receiving an indication that a first event relating to interaction by the user with the mobile advertisement has occurred, the first event occurring at a first time;
(B) receiving an indication that a second event relating to interaction by the user with the mobile advertisement has occurred, the second event occurring at a second time;
(C) determining a time interval between the first time and the second time;
(D) comparing the time interval determined in the act (C) to a threshold time interval;
(E) determining, based at least in part on a result of the comparison, whether input provided by the user to the mobile advertisement is unintentional.

2. The at least one computer-readable storage medium of claim 1, wherein the first event comprises at least one of an initial display of the mobile advertisement within the viewable area of a mobile device's screen display, receipt of input from the user to request that content relating to an advertised product and/or service be served to the mobile device, and display of content relating to the mobile advertisement within the viewable area of the mobile device's screen display.

3. The at least one computer-readable storage medium of claim 1, wherein the second event comprises at least one of receipt of input from the user to request that content relating to an advertised product and/or service be served to a mobile device, receipt of input from the user to request that loading of the content relating to the advertised product and/or service be discontinued, and receipt of input from the user to request that display of the content relating to the advertised product and/or service be discontinued.

4. The at least one computer-readable storage medium of claim 1, wherein the act (D) comprises comparing the time interval to a threshold time interval that is defined prior to the act (C).

5. The at least one computer-readable storage medium of claim 4, wherein the threshold time interval is a static time interval.

6. The at least one computer-readable storage medium of claim 5, wherein the threshold time interval is defined in relation to an amount of time it takes a user to visually process information that is shown in a viewable area of a screen display of a mobile device.

7. The at least one computer-readable storage medium of claim 5, wherein the threshold time interval is seven hundred milliseconds.

8. The at least one computer-readable storage medium of claim 1, wherein the act (E) comprises determining that the input provided by the user is unintentional if the time interval determined in the act (C) is shorter than the threshold time interval.

9. The at least one computer-readable storage medium of claim 1, wherein, if it is determined in the act (E) that the input provided by the user to the mobile advertisement is unintentional, the method comprises an act of:
(F) modifying at least one metric relating to the mobile advertisement to reflect that the user's input to the mobile advertisement is unintentional.

10. The at least one computer-readable storage medium of claim 1, wherein the instructions are executable by a device in networked communication with a mobile device used to display the mobile advertisement to the user.

11. A computer system for determining whether a user's input to a mobile advertisement is unintentional, the computer system comprising:
at least one computer processor programmed to;
receive an indication that a first event relating to interaction by the user with the mobile advertisement has occurred, the first event occurring at a first time;
receive an indication that a second event relating to interaction by the user with the mobile advertisement has occurred, the second event occurring at a second time;
determine a time interval between the first time and the second time;
compare the determined time interval to a threshold time interval;
determine, based at least in part on a result of the comparison, whether input provided by the user to the mobile advertisement is unintentional.

12. The computer system of claim 11, wherein the first event comprises at least one of an initial display of the mobile advertisement within the viewable area of a mobile device's screen display, receipt of input from the user to request that content relating to an advertised product and/or service be served to the mobile device, and display of content relating to the mobile advertisement within the viewable area of the mobile device's screen display.

13. The computer system of claim 11, wherein the second event comprises at least one of receipt of input from the user to request that content relating to an advertised product and/or service be served to a mobile device, receipt of input from the user to request that loading of the content relating to the advertised product and/or service be discontinued, and receipt of input from the user to request that display of the content relating to the advertised product and/or service be discontinued.

14. The computer system of claim 11, wherein the at least one computer processor is programmed to compare the determined time interval to a threshold time interval which is defined prior to the determination of the time interval.

15. The computer system of claim 14, wherein the threshold time interval is a static time interval.

16. The computer system of claim 15, wherein the threshold time interval is defined in relation to an amount of time it takes a user to visually process information that is shown in a viewable area of a screen display of a mobile device.

17. The computer system of claim 15, wherein the threshold time interval is seven hundred milliseconds.

18. The computer system of claim 11, wherein the at least one computer processor is programmed to determine that the input provided by the user is unintentional if the determined time interval is shorter than the threshold time interval.

19. The computer system of claim 11, wherein the at least one processor is programmed to, if it is determined that the input provided by the user to the mobile advertisement is unintentional, modify at least one metric relating to the mobile advertisement to reflect that the user's input to the mobile advertisement is unintentional.

20. The computer system of claim 11, wherein the at least one computer processor resides in a device in networked communication with a mobile device used to display the mobile advertisement to the user.
